(19) United States
(12) Patent Application Publication
(10) Pub. No.: US 2011/0206962 A1
(43) Pub. Date: Aug. 25, 2011

(54) NONAQUEOUS ELECTROLYTE SECONDARY BATTERY AND METHOD FOR MANUFACTURING THE SAME

(75) Inventors: Keisuke MINAMI, Naruto-shi (JP); Taiki NONAKA, Itano-gun (JP); Toyoki FUJIHARA, Naruto-shi (JP); Yasuhiro YAMAUCHI, Sumoto-shi (JP); Toshiyuki NOHMA, Kobe-shi (JP)

(73) Assignee: SANYO ELECTRIC CO., LTD., Osaka (JP)

(21) Appl. No.: 13/029,254

(22) Filed: Feb. 17, 2011

(30) Foreign Application Priority Data
Feb. 22, 2010 (JP) 2010-036300

(51) Int. Cl. H01M 10/36; H01M 10/04; H01M 4/04

(52) U.S. Cl. 429/94; 29/623.1

(57) ABSTRACT

An aspect of the invention provides a nonaqueous electrolyte secondary battery including a flattened electrode assembly in which a positive electrode plate containing lithium transition metal composite oxide as positive electrode active material, and a negative electrode plate containing carbon material able to insert and extract lithium ions as negative electrode active material, are stacked and wound with a separator interposed therebetween, and a protective layer constituted of inorganic oxide and an insulative binding agent provided on a surface of the negative electrode plate. The arithmetic mean surface roughness Ra of a face of the separator that contacts with the protective layer is 0.40 to 3.50 μm. With the invention, a nonaqueous electrolyte secondary battery is obtained that has enhanced formability of the flattened electrode assembly and superior output characteristics and other battery characteristics.

### TECHNICAL FIELD

The present invention relates to a nonaqueous electrolyte secondary battery that has a flattened electrode assembly in which a positive electrode plate containing positive electrode active material able to intercalate and deintercalate lithium ions and a negative electrode plate containing negative electrode active material able to intercalate and deintercalate lithium ions are stacked and wound with a separator interposed therebetween; and to a method for manufacturing such battery.

### BACKGROUND ART

As batteries for use in portable electronic and communications equipment such as compact video cameras, mobile telephones and laptop computers, nonaqueous electrolyte secondary batteries that have a carbon material, alloy or the like able to intercalate and deintercalate lithium ions as the negative electrode active material and a lithium transition metal composite oxide such as lithium cobaltate (LiCoO₂), lithium manganate (LiMn₂O₄) or lithium nickelate (LiNiO₂) as the positive electrode active material have been brought into practical use due to being batteries that are compact and lightweight, give high voltage, and moreover can be charged or discharged with high capacity.

Recent years have seen vigorous development of electric vehicles (EVs), hybrid electric vehicles (HEVs) and the like that use nonaqueous electrolyte secondary batteries. In order to heighten space efficiency and heat dissipation ability, it is desirable that a nonaqueous electrolyte secondary battery for use in EVs or in HEVs have a prismatic shape, with the battery elements housed in a prismatic battery outer can.

As an example, the structure of a prismatic nonaqueous electrolyte secondary battery will now be described using FIG. 1. FIG. 1A is a front view (transparent view) of a prismatic nonaqueous electrolyte secondary battery 30, and FIG. 1B is a cross-sectional view along line IB-IB in FIG. 1A.

In the prismatic nonaqueous electrolyte secondary battery 30, a flattened electrode assembly 1 in which a positive electrode plate (not shown) and a negative electrode plate (not shown) are stacked and wound with a separator (not shown) interposed is housed inside a prismatic outer can 2 with nonaqueous electrolyte, and the outer can 2 is sealed by a sealing plate 3. This flattened electrode assembly 1 has, at one end in the direction of the axis of winding, a positive electrode substrate exposed portion 4 where the positive electrode active material mixture layer is not formed, and at the other end, a negative electrode substrate exposed portion 5 where the negative electrode active material mixture layer is not formed. The positive electrode substrate exposed portion 4 is connected via a positive electrode collector 6 to a positive electrode terminal 7, and the negative electrode substrate exposed portion 5 is connected via a negative electrode collector 8 to a negative electrode terminal 9.

A positive electrode collector receiving portion (not shown) is connected to the portion opposite the positive electrode collector 6 with the positive electrode substrate exposed portion 4 interposed, and a negative electrode collector receiving portion 13 is connected to the portion opposite the negative electrode collector 8 with the negative electrode substrate exposed portion 5 interposed. The positive electrode terminal 7 and the negative electrode terminal 9 are fixed to the sealing plate 3 with insulators 11, 12, respectively, interposed. The positive electrode terminal 7 and the negative electrode terminal 9 have each a plate-like part 7a, 9a, respectively, that is disposed parallel to the sealing plate 3, and a bolt part 7b, 9b, respectively, that is connected to the plate-like part 7a, 9a. By means of these bolt parts 7b, 9b, the battery is connected to another, adjacent prismatic nonaqueous electrolyte secondary battery.

The prismatic nonaqueous electrolyte secondary battery 30 is fabricated by the following procedure. First, insulators (not shown) are disposed on the inside of the through-hole (not shown) provided in the sealing plate 3, and on the battery outer surface and inner surface around the periphery of the through-hole. Then the positive electrode collector 6 is positioned on the insulator located on the battery inner surface of the sealing plate, in such a manner that the through-hole of the sealing plate 3 and the through-hole (not shown) provided in the positive electrode collector 6 are aligned. After that, the insertion portion (not shown) of the positive electrode terminal 7 is inserted from the outside of the battery through the through-hole of the sealing plate 3 and the through-hole of the positive electrode collector 6. With such state, the diameter of the bottom portion (battery inside portion) of the insertion portion is widened, and the positive electrode terminal 7, together with the positive electrode collector 6, is fixed by crimping to the sealing plate 3.

The procedure is the same for the negative electrode, with the negative electrode terminal 9, together with the negative electrode collector 8, being fixed by crimping to the sealing plate 3. As a result of such operations, the members are integrated, and also, the positive electrode collector 6 is connected conductively to the positive electrode terminal 7, and the negative electrode collector 8 to the positive electrode terminal 9. The positive and negative terminals 7, 9 protrude from the sealing plate 3 in such a state as to be insulated from the sealing plate 3.

After that, the flattened electrode assembly 1, integrated with the sealing plate 3, is inserted into the outer can 2, and the sealing plate 3 is laser-welded to the mouth portion of the outer can 2. Then nonaqueous electrolyte is poured in though the electrolyte pour hole (not shown) and the electrolyte pour hole is sealed.

Although development of various kinds has been carried out concerning nonaqueous electrolyte secondary batteries, further improvement of safety is required concerning the nonaqueous electrolyte secondary batteries that are used in the aforementioned EVs, HEVs and the like.

Various kinds of measures concerning the battery materials or mechanisms, etc., are being considered in order to improve the safety of nonaqueous electrolyte secondary batteries. As an example, JP-A-2009-91461 discloses the technology that provides on the surface of either the positive or negative electrode plate an insulative protective layer constituted of alumina or the like inorganic oxide and an insulative binding agent, with the purpose of preventing internal short-circuits.

However, when a flattened electrode assembly is fabricated using a negative electrode plate on which a protective layer constituted of alumina or other inorganic oxide and an insulative binding agent has been formed based on the related art, the formability of the electrode assembly declines. Such decline in the formability of the electrode assembly will produce adverse effects such as the electrode assembly being too thick to be inserted into the outer can, and this could result in a decline in yield. In addition, there could be decline in the output characteristics or other characteristics of the nonaqueous electrolyte secondary battery that is obtained.

The inventors discovered, as a result of many and various investigations, that the decline in the formability of the electrode assembly when a flattened electrode assembly is fabricated using a negative electrode plate on which a protective layer is formed, is due to a decline in the adhesion between the separator and the protective layer formed on the negative electrode plate surface.

JP-A-9-245762 discloses that if a separator with arithmetic mean surface roughness Ra of 0.3 to 0.6 μm is used, the adhesion between the electrode plate and the separator will improve after the electrode assembly is hot-pressed. However, in JP-A-9-245762, the provision of a protective layer constituted of inorganic oxide and an insulative binding agent on the negative electrode plate surface is not disclosed.

### SUMMARY

An advantage of some aspects of the present invention is to improve the formability of the electrode assembly in flattened electrode assemblies that use a negative electrode plate on which a protective layer constituted of alumina or other inorganic oxide and an insulative binding agent is formed.

According to an aspect of the invention, a nonaqueous electrolyte secondary battery includes a flattened electrode assembly in which a positive electrode plate containing lithium transition metal composite oxide as positive electrode active material, and a negative electrode plate containing carbon material able to insert and extract lithium ions as negative electrode active material, are stacked and wound with a separator interposed therebetween, and a protective layer constituted of inorganic oxide and an insulative binding agent provided on a surface of the negative electrode plate, an arithmetic mean surface roughness Ra of a face of the separator that contacts with the protective layer being from 0.40 to 3.50 μm.

The inventors discovered, as a result of investigation, that by controlling the arithmetic mean surface roughness Ra of the face of the separator that contacts with the protective layer formed on the negative electrode plate, it is possible to enhance the adhesion between the separator and the protective layer and thereby to improve the formability of the electrode assembly.

With the present invention, making the arithmetic mean surface roughness Ra of the face of the separator that contacts with the protective layer to be 0.40 μm or greater enhances the adhesion between the separator and the protective layer and whereby the formability of the electrode assembly is improved. It is considered that the advantageous effects of the invention can be obtained if the arithmetic mean surface roughness Ra of the face of the separator that contacts with the protective layer is 3.50 μm or lower.

For the inorganic oxide contained in the protective layer of the invention, at least one selected from the group consisting of alumina, titania and zirconia may be used. Furthermore, it is preferable that the inorganic oxide that is used have an average particle diameter of 0.1 to 1.0 μm.

For the insulative binding agent contained in the protective layer, one of the binders generally used in nonaqueous electrolyte secondary batteries may be used. Specific examples of such include copolymer containing acrylonitrile structure, polyimide resin, styrenebutadiene rubber (SBR), ethylene tetrafluoroethylene (ETFE) copolymer, polyvinylidene fluoride (PVdF), polytetrafluoroethylene (PTFE), carboxymethylcellulose (CMC) and the like.

It is preferable that the separator used in the invention have differing arithmetic mean surface roughness Ra on its front and rear faces, and be disposed so that a face with the larger arithmetic mean surface roughness Ra contacts with the protective layer formed on the negative electrode plate. In such case, a face of the separator that contacts with the positive electrode plate may have an arithmetic mean surface roughness Ra of 0.05 to 0.25 μm.

The separator sometimes has differing arithmetic mean surface roughness Ra on its front and rear faces, depending on the manufacturing method. This is because when the strip-form separator moves over the roller during the separator manufacturing process, the arithmetic mean surface roughness Ra of the face of the separator that is in contact with the roller becomes smaller than that of the other face, due to the friction with the roller. Sometimes, for enhancement of production efficiency, multiple separators laid over each other are made to move over the roller, and in such case, when the separators are peeled off after passing the roller, the faces that are peeled off have larger arithmetic mean surface roughness Ra than the face that contacted with the roller.

Because of this, when cost aspects are taken into account there is a need to deal with using not only separators with equal front and rear arithmetic mean surface roughness Ra but also separators with differing front and rear arithmetic mean surface roughness Ra.

However, it is considered that in cases where the separator has large arithmetic mean surface roughness Ra on both front and rear faces, the active material mixture layer will bite deep into the separator, and there will be high probability that internal short-circuits will occur even though a protective layer is provided on the negative electrode plate.

The inventors discovered that the adhesion of the positive electrode plate to the separator is high compared with that of a negative electrode plate on which a protective layer is formed. It was therefore understood that it will be possible to make small the arithmetic mean surface roughness Ra of a face of the separator that contacts with the positive electrode plate.

In view of the foregoing, it is preferable, when using a separator with differing front and rear arithmetic mean surface roughness Ra, and a negative electrode plate on which a protective layer is formed, that the face with the larger arithmetic mean surface roughness Ra be disposed so as to contact with the protective layer formed on the negative electrode plate. Such structure enhances the adhesion between the separator and the protective layer formed on the negative electrode plate and also lowers the probability of short-circuits arising between the positive and negative electrodes.

Accordingly, in the present invention, the arithmetic mean surface roughness Ra of the face of the separator that contacts with the protective layer formed on the negative electrode plate (the face with the larger arithmetic mean surface roughness Ra) is 0.40 to 3.50 μm, in conformance with the foregoing discussion. Also, although the adhesion strength between the positive electrode plate and the separator will not be inadequate, it will be preferable that the arithmetic mean surface roughness Ra of the face of the separator that contacts with the positive electrode plate (the face with the smaller arithmetic mean surface roughness Ra) be 0.05 to 0.25 μm in order to avoid the active material mixture layer biting deep into the separator.

With the nonaqueous electrolyte secondary battery of the invention, a carbon material able to intercalate and deintercalate lithium ions may be used as the negative electrode active material. Examples of such carbon material able to intercalate and deintercalate lithium ions include graphite, non-graphitizable carbon, graphitizable carbon, fibrous carbon, coke, carbon black and the like. It is particularly preferable that graphite be used.

With the nonaqueous electrolyte secondary battery of the invention, it is preferable that the packing density of the negative electrode plate be 0.9 to 1.4 g/cm³, more preferably 1.0 to 1.2 g/cm³. It is not desirable that the packing density of the negative electrode plate be under 0.9 g/cm³, since then the energy density of the battery will fall. Neither is it desirable that the packing density of the negative electrode plate exceed 1.4 g/cm³, since then the expansion and contraction of the electrodes due to charge/discharge will be large. As used here, the “packing density of the negative electrode plate” means the packing density of the negative electrode active material mixture layer containing the negative electrode active material, and does not include the protective layer formed on the negative electrode plate surface, nor the negative electrode substrate.

With the nonaqueous electrolyte secondary battery of the invention, a lithium transition metal composite oxide able to intercalate and deintercalate lithium ions may be used as the positive electrode active material. Examples of such lithium transition metal composite oxide able to intercalate and deintercalate lithium ions include lithium cobaltate (LiCoO₂), lithium manganate (LiMn₂O₄), lithium nickelate (LiNiO₂), lithium nickel-manganese composite oxide (LiNi₁₋ₓMnₓO₂(0<x<1)), lithium nickel-cobalt composite oxide (LiNi₁₋ₓCoₓO₂(0<x<1)), lithium nickel-cobalt-manganese composite oxide (LiNiₓMn_{y}Co_{z}O₂(0<x<1, 0≦y<1, 0<z<1, x+y+z=1)) and the like. Also, the foregoing lithium transition metal composite oxides may be used with Al, Ti, Zr, Nb, B, Mg, Mo, or the like, added. As an example, one may cite the lithium transition metal composite oxide expressed by (LiNi₁₊ₐNiₓCo_{y}Mn_{b}O₂ (M=at least one element selected from among Al, Ti, Zr, Nb, B, Mg and Mo; 0≦a≦0.2, 0.2≦x≦0.5, 0.2≦y≦0.5, 0.2≦z≦0.4, 0≦b≦0.02, a+b+x+y+z=1).

With the nonaqueous electrolyte secondary battery of the invention, it is preferable that the packing density of the positive electrode plate be 2.5 to 2.9 g/cm³, more preferably 2.5 to 2.8 g/cm³. As used here, the “packing density of the positive electrode plate” means the packing density of the positive electrode active material mixture layer containing the positive electrode active material, and does not include the positive electrode substrate.

It is not desirable that the packing density of the positive electrode plate be under 2.5 g/cm³, since then adequate output characteristics could not be obtained. Neither is it desirable that the packing density of the positive electrode plate exceed 2.8 g/cm³, since then the expansion of the substrate will be large, and as a result the electrode plate could warp and the adhesion between the positive electrode plate and the separator could decrease, so that poor pressure resistance could occur due to misalignment during winding.

With the nonaqueous electrolyte secondary battery of the invention, it is preferable that a porous-material separator made of polypropylene (PP), polyethylene (PE) or other polyolefin be used as the separator. In addition, a separator with a three-layer structure of PP and PE (PP+PE+PP or PE+PP+PE) may be used.

As the nonaqueous solvent (organic solvent) constituting the nonaqueous electrolyte in the nonaqueous electrolyte secondary battery of the invention, one of the carbonates, lactones, ethers, esters or the like that are generally used in nonaqueous electrolyte secondary batteries may be used. Alternatively, two or more of such solvents may be used mixed together. Of these, it is preferable that a carbonate, lactone, ether, ketone, ester, and the like be used, more preferably carbonate.

For example, a cyclic carbonate such as ethylene carbonate, propylene carbonate or butylene carbonate, or a chain carbonate such as dimethyl carbonate, ethylmethyl carbonate or diethyl carbonate may be used. It is particularly preferable that a mixed solvent of cyclic carbonate and chain carbonate be used. In addition, an unsaturated cyclic carbonate ester such as vinylene carbonate (VC) may be added to the nonaqueous electrolyte.

As the solute for the nonaqueous electrolyte in the nonaqueous electrolyte secondary battery of the invention, one of the lithium salts that are generally used as solute in nonaqueous electrolyte secondary batteries may be used. Examples of such lithium salts include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄ and the like, or a mixture of these. Out of these, LiPF₆ (lithium hexafluorophosphate) will preferably be used. It is preferable that the amount of solute that is dissolved in the nonaqueous solvent be 0.5 to 2.0 mol/L.

According to another aspect of the invention, a method for manufacturing a nonaqueous electrolyte secondary battery of the invention includes: fabricating an electrode assembly by stacking and winding a strip-form positive electrode plate and a strip-form negative electrode plate with a separator interposed therebetween, and forming the electrode assembly into a flattened shape by pressing in a state of 5 to 35° C., in which the strip-form positive electrode plate contains lithium transition metal composite oxide as positive electrode active material, the strip-form negative electrode plate, on a surface of which a protective layer constituted of inorganic oxide and an insulative binding agent is provided, contains a carbon material able to intercalate and deintercalate lithium ions as the negative electrode active material, and the separator has an arithmetic mean surface roughness Ra of 0.40 to 3.50 μm on a face that contacts the protective layer.

If an electrode assembly is formed into a flattened shape by pressing while being heated, there is risk that short-circuit faults could occur due to fall in the battery characteristics, or membrane rupture, resulting from rise in the air permeability of the separator caused by the heat.

With the present invention, the electrode assembly is pressed and formed into a flattened shape in a normal-temperature state without being heated, so that the formability is improved, and also, a nonaqueous electrolyte secondary battery can be manufactured in which battery characteristic decline or short-circuits will not occur. As used here, “normal temperature” means 5 to 35° C.

In the foregoing method for manufacturing a nonaqueous electrolyte secondary battery, it is preferable that the arithmetic mean surface roughness Ra of a face of the separator that contacts with the positive electrode plate be 0.05 to 0.25 μm.

### BRIEF DESCRIPTION OF THE DRAWINGS

The invention will be described with reference to the accompanying drawings, wherein like numbers reference like elements.

FIGS. 1A and 1B are views of a prismatic nonaqueous electrolyte secondary battery. FIG. 1A is a front view (transparent view) of the prismatic nonaqueous electrolyte secondary battery, and FIG. 1B is a cross-sectional view along line IB-IB in FIG. 1A.

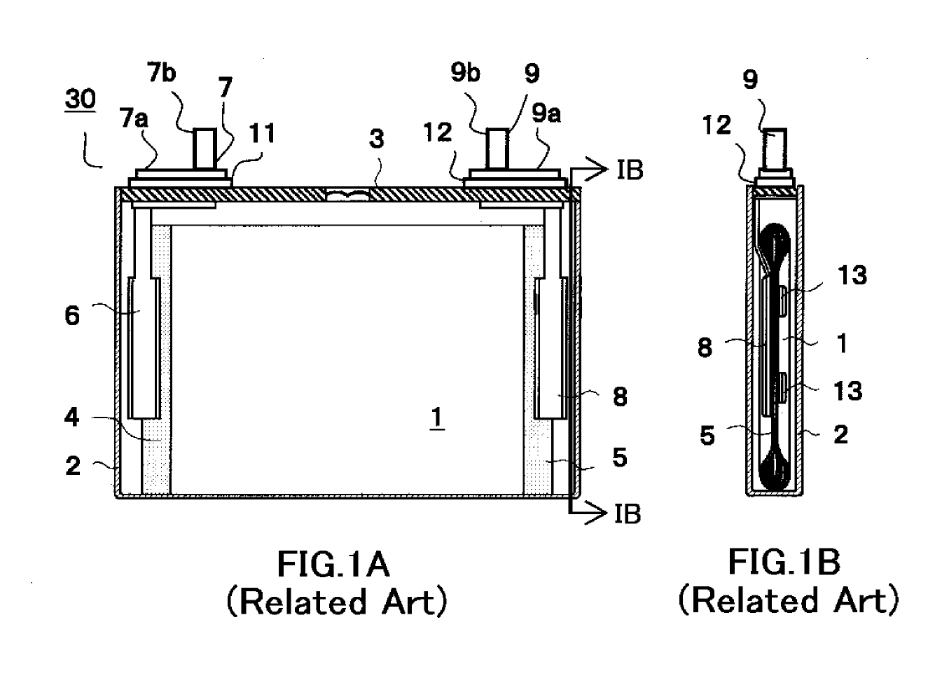

FIGS. 2A to 2C are drawings that explicate a method for measuring the adhesion strength between the electrodes and the separator.

### DESCRIPTION OF EXEMPLARY EMBODIMENTS

The invention is described below in detail using reference experiments, embodiments, and comparative examples. It should be understood, however, that the embodiments described below are intended by way of examples for realizing the technical concepts of the invention, not by way of limiting the invention to these particular embodiments. The invention can equally well be applied to many different variants of these embodiments without departing from the technical concepts set forth in the claims.

First will be described the methods for fabricating the positive electrode plate and the negative electrode plate that are common to the reference experiments, embodiments, and comparative examples.

Fabrication of Positive Electrode Plate

Li₂CO₃ and (Ni_{0.35}Co_{0.35}Mn_{0.3})₃O₄ were mixed so that the mole ratio of the Li to the (Ni_{0.35}Co_{0.35}Mn_{0.3}) was 1:1. Next, this mixture was fired in an air atmosphere at 900° C. for 20 hours, and thereby a lithium transition metal composite oxide expressed by LiNi_{0.35}Co_{0.35}Mn_{0.3}O₂ was obtained, to be used as the positive electrode active material. A positive electrode slurry was then fabricated by mixing the positive electrode active material obtained in the foregoing manner with flaked graphite and carbon black serving as conductive agents, and a solution of polyvinylidene fluoride (PVdF) in N-methyl-2-pyrolidone (NMP) serving as a binding agent, so that the proportions by mass of the lithium transition metal composite oxide, flaked graphite, carbon black and PVdF were 88:7:2:3. The positive electrode slurry thus fabricated was applied to one face of a piece of aluminum alloy foil (thickness 15 μm) serving as the positive electrode substrate. This was then allowed to dry and the NMP that had been used as solvent during slurry fabrication was removed, thus forming a positive electrode active material mixture layer. By the same method, a positive electrode active material mixture layer was also formed on the other face of the aluminum alloy foil. After that, a positive electrode plate A was fabricated by rolling to a particular packing density (2.61 g/cm³) using a roller, and cutting to particular dimensions.

A positive electrode plate B was fabricated in the same way as positive electrode plate A, except that the positive electrode plate packing density was 2.39 g/cm³.

Furthermore, a positive electrode plate C was fabricated in the same way as positive electrode plate A, except that the positive electrode plate packing density was 2.88 g/cm³.

Fabrication of Negative Electrode Plate

A negative electrode slurry was fabricated by mixing synthetic graphite serving as negative electrode active material, carboxymethylcellulose (CMC) serving as thickening agent, and styrenebutadiene rubber (SBR) serving as a binding agent, into water. Such mixing was performed so that the proportions by mass of the negative electrode active material, CMC and SBR were 98:1:1. Then the negative electrode slurry thus fabricated was applied to one face of a piece of copper foil (thickness 10 μm) serving as the negative electrode substrate. This was then allowed to dry and the water that had been used as solvent during slurry fabrication was removed, thus forming a negative electrode active material mixture layer. By the same method, a negative electrode active material mixture layer was also formed on the other face of the copper foil. After that, the resulting item was rolled to a particular packing density (1.11 g/cm³) using a roller.

Next, a protective layer slurry was fabricated by mixing alumina powder, a binding agent (copolymer containing acrylonitrile structure), and NMP as solvent, so as to be in the proportion 30:0.9:69.1 by mass, and implementing mixed dispersion treatment on such mixture with a bead mill. The protective layer slurry thus fabricated was applied to one of the negative electrode active material mixture surfaces, and then the NMP that had been used as solvent was removed by drying, thus forming on the negative electrode plate an insulative protective layer constituted of alumina and a binding agent. By the same method, a protective layer was also formed on the other negative electrode active material mixture surface. After that, a negative electrode plate A was fabricated by cutting to particular dimensions. Note that the thickness of the aforementioned layer constituted of alumina and a binding agent was 3 μm.

A negative electrode plate B was fabricated in the same way as negative electrode plate A, except that no protective layer was provided.

A negative electrode plate C was fabricated in the same way as negative electrode plate A, except that the negative electrode plate packing density was 0.90 g/cm³ and no protective layer was provided.

The packing densities of the foregoing positive electrode plates and negative electrode plates were determined by the method below.

### [Measurement of Packing Density]

A 10-cm² portion of electrode plate was cut out, and the mass A (g) and thickness C (cm) of such 10-cm² electrode plate portion were measured. In addition, the mass B (g) and thickness D (cm) of the substrate of such 10-cm² electrode plate portion were measured. Then the packing density was found using the following equation:

Packing density=(A−B)/[(C−D)×10 cm²]

Where a protective layer was formed on the negative electrode plate surface, this was taken to be the packing density of the negative electrode active material mixture layer, excluding the protective layer.

### Reference Experiments

As reference experiments, the arithmetic mean surface roughness Ra of the positive electrode plates A to C and negative electrode plates A to C, and of each face of the separator, were investigated using the method below.

Measurement of Arithmetic Mean Surface Roughness Ra of Positive and Negative Electrode Plates and Separator

The arithmetic mean surface roughness Ra of the positive electrode plates, negative electrode plates and separator were found by observing their surfaces with a laser microscope (VK-9710, Keyence Corporation) and analyzing the surfaces by using analysis software (VK-Analyzer, Keyence Software Corporation) under conditions based on JIS B0601:1994.

Next, the adhesion strengths of the positive electrode plates A to C and negative electrode plates A to C to a separator with differing arithmetic mean surface roughnesses Ra were investigated by the following method.

Measurement of Electrode Plate-Separator Adhesion Strength

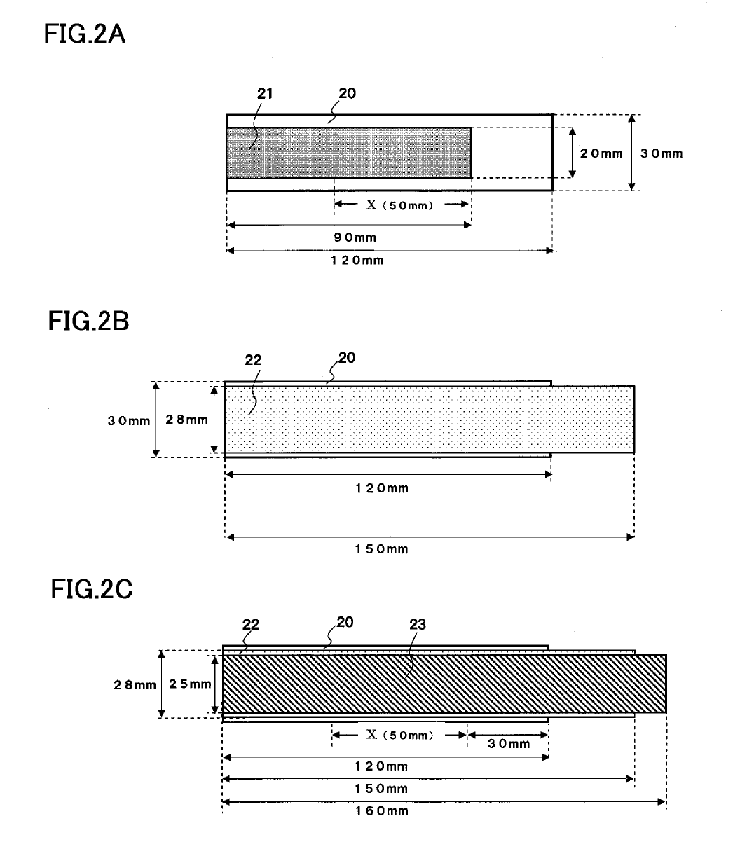

First, as shown in FIG. 2, a 120-mm-long, 30-mm-wide plate-form jig 20 was fixed in a mount (not shown), and onto the upper surface thereof a 90-mm-long, 20-mm-wide double-sided adhesive tape 21 was affixed, in such a manner that the widthwise centerline of the plate-form jig 20 was aligned with the widthwise centerline of the double-sided adhesive tape 21. One lengthwise end of the plate-form jig 20 was aligned with one lengthwise end of the double-sided adhesive tape 21 (FIG. 2A).

Next, a 150-mm-long, 28-mm-wide separator 22 was affixed onto the double-sided adhesive tape 21, in such a manner that the widthwise centerline of the separator 22 was aligned with the widthwise centerline of the double-sided adhesive tape 21. One lengthwise end of the separator 22 was aligned with the end of the double-sided adhesive tape 21 that was aligned with one lengthwise end of the plate-form jig 20 (FIG. 2B).

Then, a 160-mm-long, 25-mm-wide test electrode 23 (positive electrode plate or negative electrode plate) was disposed onto the separator 22, in such a manner that the widthwise centerline of the test electrode 23 was aligned with the widthwise centerline of the separator 22. One lengthwise end of the test electrode 23 was aligned with the end of the separator 22 that was aligned with one lengthwise end of the double-sided adhesive tape 21 (FIG. 2C).

After that, the whole surface of the test electrode 23 (positive electrode plate or negative electrode plate) located on the plate-form jig 20 was pressed from above with a load of 40 kN. Then, using a tensile tester (SHIMADZU AG-IS, Shimadzu Corporation), a peel test was conducted in which a section of the test electrode 23 (positive electrode plate or negative electrode plate) extending 1 cm from the end that was not located on the plate-form jig 20 was gripped and pulled with velocity of 1 mm/sec in the vertical direction relative to the plate-form jig 20. The adhesion strength was taken (in accordance with JIS C6481) to be the convex point average stress in a section X (FIG. 2A, FIG. 2C) extending 50 mm in the lengthwise direction of the test electrode 23 from the position on the test electrode 23 that corresponded to the lengthwise end of the double-sided adhesive tape 21 (end that was not aligned with the end of the plate-form jig 20).

The packing densities, arithmetic mean surface roughnesses Ra, and adhesion strengths to the separator (with Ra=0.16 μm, 0.42 μm, 0.46 μm and 0.62 μm) for positive electrode plates A to C and negative electrode plates A to C are compiled in Tables 1 and 2. A dash “-” in the tables indicates that the item was not measured.

TABLE 1

| | | | Adhesion strength (mN/cm) | |
|---|---|---|---|---|
| | | Arithmetic | Separator | Separator |
| | | mean | arithmetic | arithmetic |
| | Packing | surface | mean surface | mean surface |
| | density | roughness | roughness | roughness |
| | (g/cm³) | Ra (μm) | Ra = 0.16 μm | Ra = 0.62 μm |
| Positive electrode | 2.61 | 6.64 | 74.3 | 133.9 |
| plate A | | | | |
| Positive electrode | 2.39 | 7.12 | 108.0 | 139.7 |
| plate B | | | | |
| Positive electrode | 2.88 | 5.88 | 55.0 | 91.0 |
| plate C | | | | |

As Table 1 shows, although the adhesion strength of positive electrode plates A to C, on which no protective layer was formed, to the separator varied with the arithmetic mean surface roughnesses Ra of the separator, in each case the adhesion strength was 50 mN/cm or higher. From this it will be seen that even if the arithmetic mean surface roughnesses Ra of the face of the separator that contacts with the positive electrode plate is made to be smaller than 0.40 μm, the adhesion between the positive electrode plate and the separator will not become inadequate. In addition, it will be seen that the arithmetic mean surface roughness Ra of the positive electrode plates varies with variation in the packing density of the positive electrode plates, and along with that, their adhesion strength to the separator also varies. Hence, it is preferable that the packing density of the positive electrode plate be no more than 2.88 g/cm³, or more preferably no more than 2.80 g/cm³.

TABLE 2

| | | | Arithmetic | Adhesion strength (mN/cm) | | | | |
|---|---|---|---|---|---|---|---|---|
| | | | mean surface | Separator | Separator | Separator | Separator | Separator |
| | | | roughness | arithmetic | arithmetic | arithmetic | arithmetic | arithmetic |
| | Packing | | Ra (μm) of | mean surface | mean surface | mean surface | mean surface | mean surface |
| | density | Protective | negative | roughness | roughness | roughness | roughness | roughness |
| | (g/cm³) | layer | electrode plate | Ra = 0.16 μm | Ra = 0.42 μm | Ra = 0.46 μm | Ra = 0.62 μm | Ra = 2.14 μm |
| Negative | 1.11 | Present | 2.48 | 44.6 | 52.5 | 54.5 | 58.0 | 59.2 |
| electrode | | | | | | | | |
| plate A | | | | | | | | |
| Negative | 1.11 | Absent | 7.28 | 50.4 | — | — | 51.2 | — |
| electrode | | | | | | | | |
| plate B | | | | | | | | |
| Negative | 0.9 | Absent | 7.90 | 48.7 | — | — | 49.8 | — |
| electrode | | | | | | | | |
| plate C | | | | | | | | |

Concerning the negative electrode, as Table 2 shows, comparable adhesion strength was exhibited with negative electrode plates B and C, on which no protective layer was formed, regardless of the arithmetic mean surface roughness Ra of the separator. By contrast, with negative electrode plate A, on which a protective layer was formed, the adhesion strength was a low value of 44.6 mN/cm when the arithmetic mean surface roughness Ra of the separator was 0.16 μm. However, when the arithmetic mean surface roughness Ra of the separator was 0.42 μnm, 0.46 μm, 0.62 μm or 2.14 μm, the adhesion strength was a value of 50 mN/cm or higher. From these facts, it will be seen that by making the arithmetic mean surface roughness Ra of the face of the separator that contacts with the protective layer formed on the negative electrode plate range from 0.40 μm or higher, the adhesion between the protective layer formed on the negative electrode plate surface and the separator can be rendered high.

On the basis of the foregoing reference experiment results, a flattened electrode assembly was actually fabricated, and the effects that the arithmetic mean surface roughness Ra of the separator exerts on the formability of the flattened electrode assembly were examined.

### Embodiment 1

### Fabrication of Flattened Electrode Assembly

First, the positive electrode plate A and negative electrode plate A were prepared. The positive electrode plate A used was a 104.8-mm-wide, 3870-mm-long, 69 μm-thick strip, having at one end in the lengthwise direction a substrate exposed portion (width 15.2 mm) where the electrode active material mixture layer was not formed on either of the substrate surfaces. Also, the negative electrode plate A used was a 106.8-mm-wide, 4020-mm-long, 71 μm thick strip, having at one end in the lengthwise direction a substrate exposed portion (width 10.0 mm) where the electrode active material mixture layer was not formed on either of the substrate surfaces.

Next, three members, namely, the positive electrode plate A, negative electrode plate A and a separator (100-mm-wide, 4310-mm-long and 30 μm thick) constituted of microporous polyethylene membrane, were aligned and laid over one another in such a manner that the differing substrate exposed portions protruded with mutually opposite orientations relative to the winding direction, and that the separator was interposed between the active material mixture layers of differing polarity. Then the three members were would by a winder. The winding end portion of the wound electrode assembly was fixed by means of insulative winding fastening tape. The arithmetic mean surface roughness Ra of the face of the separator that contacted with the positive electrode plate A was 0.16 μm and the arithmetic mean surface roughness Ra of the face that contacted with the negative electrode plate A was 0.62 μm.

After that, the electrode assembly wound into a spiral form and pressed with 110 kN at room temperature (25° C.) to fabricate the flattened electrode assembly of the Embodiment 1.

### Comparative Example 1

The flattened electrode assembly of the Comparative Example 1 was fabricated in the same way as that in the Embodiment 1, except that the separator was disposed so that the face of the separator with 0.62 μm arithmetic mean surface roughness Ra contacted with the positive electrode plate A and the face with 0.16 μm arithmetic mean surface roughness Ra contacted with the negative electrode plate A.

### Embodiment 2

The flattened electrode assembly of the Embodiment 2 was fabricated in the same way as that in the Embodiment 1, except that the separator was disposed so that the face of the separator with 0.42 μm arithmetic mean surface roughness Ra contacted with the positive electrode plate A and the face with 0.46 μm arithmetic mean surface roughness Ra contacted with the negative electrode plate A.

### Embodiment 3

The flattened electrode assembly of the Embodiment 3 was fabricated in the same way as that in the Embodiment 1, except that the separator was disposed so that the face of the separator with 0.46 μm arithmetic mean surface roughness Ra contacted with the positive electrode plate A and the face with 0.42 μm arithmetic mean surface roughness Ra contacted with the negative electrode plate A.

Judgment of Electrode Assembly Formability

The formability of the flattened electrode assemblies fabricated in the Embodiments 1 to 3 and the Comparative Example 1 was judged from the thickness of the central portion of the flattened electrode assemblies (electrode assembly thickness).

The results of the investigation of the formability of the flattened electrode assemblies of the Embodiments 1 to 3 and the Comparative Example 1 are set forth in Table 3. The electrode assembly thicknesses in Table 3 for the electrode assemblies of the Embodiments 1 to 3 and the Comparative Example 1 are percentages relative to the thickness of the electrode assembly of the Embodiment 1 as 100%.

TABLE 3

| | Separator | Separator | | |
|---|---|---|---|---|
| | arithmetic mean | arithmetic mean | | |
| | surface roughness | surface roughness | Adhesion strength | |
| | Ra on positive | Ra on negative | between negative | |
| | electrode plate side | electrode plate side | electrode plate and | Electrode assembly |
| | (μm) | (μm) | separator (mN/cm) | thickness (%) |
| Embodiment 1 | 0.16 | 0.62 | 58.0 | 100 |
| Embodiment 2 | 0.42 | 0.46 | 52.5 | 100 |
| Embodiment 3 | 0.46 | 0.42 | 54.5 | 100 |
| Comparative | 0.62 | 0.16 | 44.6 | 103 |
| Example 1 | | | | |

From the fact that the electrode assembly formability was low with the flattened electrode assembly of the Comparative Example, in which the negative electrode plate A, on which a protective layer was formed, contacted with a face of the separator having arithmetic mean surface roughness Ra of 0.16 μm, whereas with the Embodiments 1 to 3, in which the negative electrode plate A, on which a protective layer was formed, contacted with a face of the separator having arithmetic mean surface roughness Ra of 0.42 μm, 0.46 μm, and 0.62 μm respectively, the adhesion strength between the protective layer formed on the negative electrode plate A and the separator was high, it will be seen that the flattened electrode assembly formability is excellent.

From the foregoing it will be seen that the electrode assembly formability can be enhanced by making the arithmetic mean surface roughness Ra of the face of the separator that contacts with the protective layer formed on the negative electrode plate range from 0.40 μm or higher.

### ADVANTAGE OF THE INVENTION

Thus, with the present invention, by making the arithmetic mean surface roughness Ra of the face of the separator that contacts with the protective layer formed on the negative electrode plate range from 0.40 to 3.50 μm, the adhesion strength between the protective layer formed on the negative electrode plate and the separator can be rendered high and the formability of the flattened electrode assembly can be enhanced.

What is claimed is:

1. A nonaqueous electrolyte secondary battery comprising:
a flattened electrode assembly in which a positive electrode plate containing lithium transition metal composite oxide as positive electrode active material, and a negative electrode plate containing carbon material able to intercalate and deintercalate lithium ions as negative electrode active material, are stacked and wound with a separator interposed therebetween; and
a protective layer constituted of inorganic oxide and an insulative binding agent provided on a surface of the negative electrode plate;
an arithmetic mean surface roughness Ra of a face of the separator that contacts with the protective layer being 0.40 to 3.50 μm.

2. The nonaqueous electrolyte secondary battery according to claim 1, wherein the inorganic oxide is at least one selected from the group consisting of alumina, titania and zirconia.

3. The nonaqueous electrolyte secondary battery according to claim 1, wherein the separator has differing arithmetic mean surface roughness Ra on front and rear faces, and a face with the larger arithmetic mean surface roughness Ra contacts with the protective layer.

4. The nonaqueous electrolyte secondary battery according to claim 3, wherein a face of the separator that contacts with the positive electrode plate has an arithmetic mean surface roughness Ra of 0.05 to 0.25 μm.

5. The nonaqueous electrolyte secondary battery according to claim 1, wherein the negative electrode active material is graphite.

6. The nonaqueous electrolyte secondary battery according to claim 1, wherein the positive electrode active material is expressed by Li₁₊ₐNiₓCo_{y}Mn_{z}M_{b}O₂ (M=at least one element selected from among Al, Ti, Zr, Nb, B, Mg and Mo; 0≦a≦0.2, 0.2≦x≦0.5, 0.2≦y≦0.5, 0.2≦z≦0.4, 0≦b≦0.02, a+b+x+y+z=1).

7. A method for manufacturing a nonaqueous electrolyte secondary battery, the method comprising:
fabricating an electrode assembly by stacking and winding a strip-form positive electrode plate and a strip-form negative electrode plate with a separator interposed therebetween; and
forming the electrode assembly into a flattened shape by pressing in a state of 5 to 35° C.;
the strip-form positive electrode plate containing lithium transition metal composite oxide as positive electrode active material,
the strip-form negative electrode plate, on a surface of which a protective layer is provided, containing a carbon material able to intercalate and deintercalate lithium ions as the negative electrode active material, and
the separator having an arithmetic mean surface roughness Ra of 0.40 to 3.50 μm on a face that contacts with the protective layer.

8. The method for manufacturing a nonaqueous electrolyte secondary battery according to claim 7, wherein the arithmetic mean surface roughness Ra of a face of the separator that contacts with the positive electrode plate is 0.05 to 0.25 μm.
